(19) United States
(12) Patent Application Publication
(10) Pub. No.: US 2026/0227730 A1
(43) Pub. Date: Aug. 6, 2026

(54) IMAGE FORMING APPARATUS

(71) Applicant: CANON KABUSHIKI KAISHA, Tokyo (JP)

(72) Inventor: SOICHI ISHII, Kanagawa (JP)

(21) Appl. No.: 19/460,148

(22) Filed: Jan. 26, 2026

(30) Foreign Application Priority Data
Jan. 30, 2025 (JP) 2025-014004
Nov. 10, 2025 (JP) 2025-189117

(51) Int. Cl. G03G 15/23; G03G 15/00

(52) U.S. Cl. CPC G03G 15/234; G03G 15/50; G03G 15/6558; G03G 2215/00721

(57) ABSTRACT

An image forming apparatus includes a photosensitive drum, a charging member, a transfer member, a first conveyance path, one or more first conveyance roller pairs disposed in the first conveyance path, a reverse conveyance member, a second conveyance, and one or more second conveyance roller pairs disposed in the second conveyance path. The second conveyance path merges with the first conveyance path at a position upstream of the transfer portion in the first conveyance direction. The second conveyance path includes a guide member configured to guide the sheet. A downstream end of the guide member in the second conveyance direction forms an upstream edge, in the first conveyance direction, of an opening portion that is a merging portion where a conveyance space of the second conveyance path communicates with a conveyance space of the first conveyance path.

### BACKGROUND

### Field of the Technology

The present disclosure relates to an image forming apparatus that forms an image on a sheet.

### Description of the Related Art

Japanese Patent Application Laid-Open No. 2009-263103 discloses an image forming apparatus including a supply path through which a sheet conveyed from a sheet feed tray is guided to an image forming position, and a reverse conveyance path through which the sheet having passed the image forming position is reversed and guided to the supply path again.

### SUMMARY

According to the present disclosure, an image forming apparatus capable of shortening a sheet conveyance path for forming images on both surfaces of a sheet can be provided.

An aspect of the present disclosure provides an image forming apparatus including a photosensitive drum, a charging member configured to charge an outer peripheral surface of the photosensitive drum at a charging portion, a transfer member configured to transfer a toner image from the photosensitive drum onto a sheet at a transfer portion, a stacking tray on which the sheet is stacked, a first conveyance path through which the sheet is conveyed from the stacking tray to the transfer portion, one or more first conveyance roller pairs disposed in the first conveyance path, a reverse conveyance member configured to reverse the sheet having passed through the transfer portion, a second conveyance path through which the sheet reversed by the reverse conveyance member is conveyed toward the transfer portion, and one or more second conveyance roller pairs disposed in the second conveyance path, wherein in a case where a conveyance direction of the sheet in the first conveyance path is a first conveyance direction and a conveyance direction of the sheet in the second conveyance path is a second conveyance direction, the second conveyance path merges with the first conveyance path at a position upstream of the transfer portion in the first conveyance direction, the second conveyance path includes a guide member configured to guide the sheet, a downstream end of the guide member in the second conveyance direction forms an upstream edge, in the first conveyance direction, of an opening portion that is a merging portion where a conveyance space of the second conveyance path communicates with a conveyance space of the first conveyance path, and as viewed in a direction of a rotation axis of the photosensitive drum, a minimum distance from the downstream end of the guide member to the transfer portion is smaller than a distance from the charging portion to the transfer portion measured along the outer peripheral surface of the photosensitive drum in a rotation direction of the photosensitive drum during image formation.

Another aspect of the present disclosure provides an image forming apparatus including a photosensitive drum, a charging member configured to charge an outer peripheral surface of the photosensitive drum at a charging portion, a transfer member configured to transfer a toner image from the photosensitive drum onto a sheet at a transfer portion, a stacking tray on which the sheet is stacked, a first conveyance path through which the sheet is conveyed from the stacking tray to the transfer portion, one or more first conveyance roller pairs disposed in the first conveyance path, a reverse conveyance member configured to reverse the sheet having passed through the transfer portion, a second conveyance path through which the sheet reversed by the reverse conveyance member is conveyed toward the transfer portion, and one or more second conveyance roller pairs disposed in the second conveyance path, wherein the transfer member is disposed between the photosensitive drum and the second conveyance path, in a case where a conveyance direction of the sheet in the first conveyance path is a first conveyance direction and a conveyance direction of the sheet in the second conveyance path is a second conveyance direction, the second conveyance path merges with the first conveyance path at a position upstream of the transfer portion in the first conveyance direction, the second conveyance path includes a guide member configured to guide the sheet, a downstream end of the guide member in the second conveyance direction forms an upstream edge, in the first conveyance direction, of an opening portion that is a merging portion where a conveyance space of the second conveyance path communicates with a conveyance space of the first conveyance path, and as viewed in a direction of a rotation axis of the photosensitive drum, a minimum distance from the downstream end of the guide member to the transfer portion is smaller than a length of a movement path of the sheet from a most downstream conveyance roller pair in the second conveyance direction among the one or more second conveyance roller pairs to the merging portion.

Features of the present disclosure will become apparent from the following description of embodiments with reference to the attached drawings. The following description of embodiments is described by way of example.

### BRIEF DESCRIPTION OF THE DRAWINGS

FIG. 1 is a section view of a printer according to a first embodiment.

FIG. 2 is a section view of part of a printer according to the first embodiment.

FIG. 3 is a section view of part of the printer according to a modification example of the first embodiment.

FIG. 4 is a section view of part of a printer according to a second embodiment.

FIG. 5 is a section view of part of a printer according to a modification example of the second embodiment.

FIG. 6 is a section view of part of a printer according to another modification example of the second embodiment.

### DESCRIPTION OF THE EMBODIMENTS

Embodiments of the present disclosure will be described below with reference to drawings. Each of the embodiments of the present disclosure described below can be implemented solely or as a combination of a plurality of the embodiments or features thereof where necessary or where the combination of elements or features from individual embodiments in a single embodiment is beneficial.

### First Embodiment

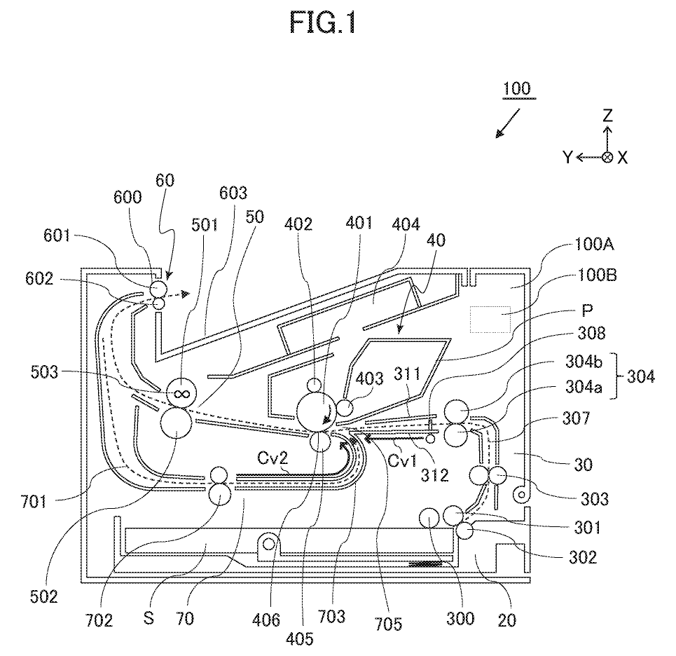

FIG. 1 is a section view illustrating a schematic configuration of a printer 100 serving as an example of an image forming apparatus. The printer 100 can form an image on a sheet S by an electrophotographic process on the basis of, for example, image information received from the outside. As the sheet S serving as a recording material (recording medium), various sheet materials of different sizes and materials can be used. Examples of the various sheet materials include paper sheets such as plain paper sheets and cardboards, sheet materials of irregular shapes such as envelopes and index paper sheets, plastic films, and cloths.

To be noted, in the present disclosure, “image forming apparatus” generally refers to an apparatus having a function to form an image on a sheet serving as a recording material (recording medium). The image forming apparatus may be a monofunctional printer, a copier, or a multifunctional apparatus. The image forming apparatus may be an apparatus that mainly forms a color image, or an apparatus that mainly forms a monochromatic image. The image forming apparatus may be a system (image forming system) in which one or more attachment devices that are integrally used with an image forming apparatus body that forms an image on a recording material are connected to the image forming apparatus body. Examples of the attachment devices include a sheet processing apparatus (finisher) that performs a process such as a binding process on sheets on which images have been formed, a conveyance apparatus that conveys the sheet from the image forming apparatus body to another apparatus, and a feeding apparatus (optional feeder) that feeds the sheet toward the image forming apparatus body.

The outline of the printer 100 will be described with reference to FIG. 1. The printer 100 includes an apparatus body 100A (casing), a cassette 20, a feed conveyance portion 30, an image forming portion 40, a fixing unit 50, a discharge reverse portion 60, a duplex conveyance portion 70, and a controller 100B.

In the description below and drawings, the vertical direction (gravity direction) in the case where the printer 100 is placed on a horizontal surface will be referred to as a Z-axis direction. The direction of the rotation axis of a photosensitive drum 401 (image bearing member) included in the printer 100 will be referred to as an X-axis direction. A direction intersecting with both the Z-axis direction and the X-axis direction will be referred to as a Y-axis direction. The X-axis direction, the Y-axis direction, and the Z-axis direction may preferably be orthogonal to each other. The positive directions and the negative directions of the directions along the respective coordinate axes will be expressed with + (plus) or - (minus) signs. For example, the positive direction of the X axis (direction indicated by an arrow X in the drawings) will be referred to as a +X direction, and the negative direction (direction opposite to the direction indicated by an arrow X in the drawings) of the X axis will be referred to as a -X direction.

The cassette 20 (sheet tray, storage chamber) is an example of a stacking tray or stacking portion on which sheets S are stacked. The feed conveyance portion 30 includes a pickup roller 300 (feed roller), a conveyance roller 301, a separation roller 302, an intermediate roller pair 303, and a registration roller pair 304. The pickup roller 300 is an example of a feeding member that feeds the sheet S from the cassette 20. The separation roller 302 is an example of a separation member that separates the sheets S by frictional force. The feed conveyance portion 30 includes a feeding path 307 (first conveyance path) that will be described later, and one or more first conveyance roller pairs disposed in the feeding path 307. The pickup roller 300, the conveyance roller 301, each roller of the intermediate roller pair 303, and each roller of the registration roller pair 304 are each an example of a conveyance roller disposed in the feeding path 307 (first conveyance path) that will be described later. The intermediate roller pair 303 and the registration roller pair 304 are an example of one or more first conveyance roller pairs.

The registration roller pair 304 includes a driving roller 304a and a driven roller 304b. The registration roller pair 304 is a conveyance roller pair that is disposed on the most downstream side of the feeding path 307 in a sheet conveyance direction in the feeding path 307.

The image forming portion 40 forms an image on the sheet S fed from the cassette 20. The image forming portion 40 includes a photosensitive drum 401, a charging roller 402 serving as a charging member that charges an outer peripheral surface 401s of the photosensitive drum 401, a toner storage portion that stores toner serving as a developer, and a developing roller 403 serving as a developing member.

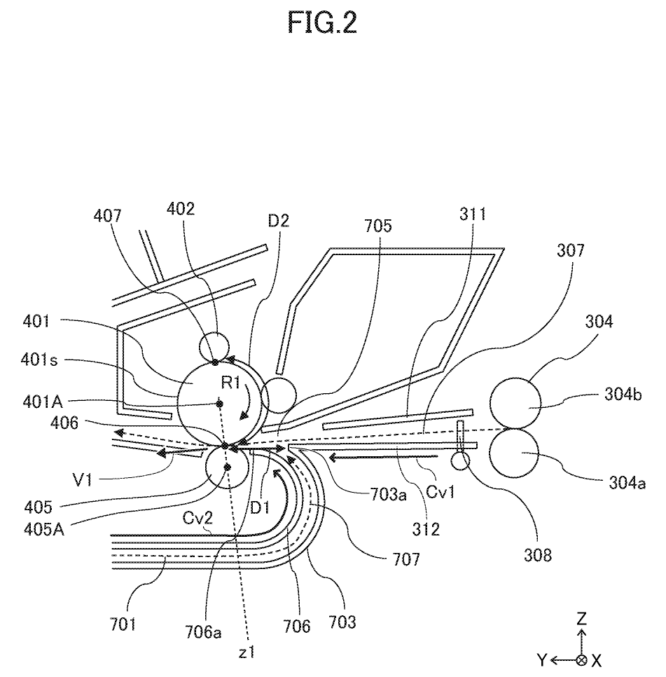

The photosensitive drum 401 is a drum-shaped image bearing member in which, for example, a photosensitive layer is formed from an organic photosensitive material on an outer peripheral portion of a cylindrical base member formed from aluminum. The photosensitive drum 401 rotates about a rotation axis extending in the X-axis direction. The charging roller 402 opposes the outer peripheral surface 401s of the photosensitive drum 401 in contact or with a predetermined gap therebetween. The opposing portion where the charging roller 402 opposes the outer peripheral surface 401s of the photosensitive drum 401 is a charging portion 407 (FIG. 2) where the outer peripheral surface 401s of the photosensitive drum 401 is charged. To be noted, as the charging member, a corona charger of a corotron type or a scorotron type may be used. The developing roller 403 rotates while bearing the toner, and supplies the toner to the photosensitive drum 401 at an opposing portion where the developing roller 403 and the photosensitive drum 401 oppose each other.

In addition, the image forming portion 40 includes a laser scanner 404 serving as an exposing unit and a transfer roller 405 serving as a transfer member. The transfer roller 405 is disposed to oppose the photosensitive drum 401, and a transfer portion 406 (transfer nip) where a toner image is transferred from the photosensitive drum 401 onto the sheet S is formed between the photosensitive drum 401 and the transfer roller 405. To be noted, as the exposing unit, for example, an LED exposing unit using a light emitting diode (LED) as a light source may be used. As the transfer member, for example, a transfer device of a corona discharge type may be used. As illustrated in FIG. 1, in the present embodiment, the transfer roller 405 is disposed between the photosensitive drum 401 and a duplex conveyance path 701 (second conveyance path) that will be described later.

In the present embodiment, the photosensitive drum 401, the charging roller 402, the developing roller 403, and the toner storage portion are part of a cartridge P detachably attached to the apparatus body 100A.

The fixing unit 50 is a unit of a thermal fixation type that performs an image fixing process by using heat and pressure. The fixing unit 50 includes a fixing roller 501 serving as a fixing member (heating member), a pressurizing roller 502 serving as a pressurizing member, and a heating portion 503 that heats the fixing roller 501. A fixing nip is formed between the fixing roller 501 and the pressurizing roller 502. The heating portion 503 may be, for example, a halogen lamp disposed in an internal space of the fixing roller 501 having a cylindrical shape. To be noted, the configuration of the fixing unit 50 is not limited to this, and, for example, a tubular film may be used as the fixing member, and a ceramic heater disposed in an internal space of the film may be used as the heating portion 503.

The discharge reverse portion 60 includes a discharge reverse roller pair 600 having a discharge roller 601 and a driven roller 602. The discharge reverse roller pair 600 is an example of a discharge member (discharge roller pair) that discharges the sheet S from the inside of the apparatus body 100A to the outside. In addition, the discharge reverse roller pair 600 also functions as a reverse conveyance member (reverse conveyance roller pair) that, in duplex printing, reverses and conveys the sheet S on a first surface of which an image has been formed to the duplex conveyance path 701. To be noted, a reverse conveyance member (reverse conveyance roller pair) different from the discharge reverse roller pair 600 may be provided. In this case, a movable guide member (switching guide, flap guide) is provided, and a configuration in which the sheet S is guided to the discharge reverse roller pair 600 in the case of discharging the sheet S, and the sheet S is guided to the reverse conveyance roller pair in the case of reversing the sheet S is employed.

A discharge tray 603 serving as a discharge stacking portion on which discharged sheets S are stacked is provided on the top surface of the apparatus body 100A.

The duplex conveyance portion 70 is a conveyance mechanism for conveying the sheet S reversed by the discharge reverse portion 60 to the image forming portion 40 again when performing duplex printing in which an image is formed on each surface of the sheet S. The duplex conveyance portion 70 includes a duplex conveyance path 701 and one or more second conveyance roller pairs (duplex conveyance roller pairs 702) disposed in the duplex conveyance path 701. In the present embodiment, only one duplex conveyance roller pair 702 is disposed in the duplex conveyance path 701 between the discharge reverse roller pair 600 and a merging portion 705, but two or more duplex conveyance roller pairs 702 may be provided. The details of the duplex conveyance path 701 will be described later.

The controller 100B includes a central processing unit (CPU), and a memory. The CPU loads and executes a program stored in the memory, and controls the operation of the printer 100. The memory serves as a storage for a program and data, and also provides a work space for the CPU to execute the program. The memory is an example of a non-transitory recording medium storing a program for controlling the image forming apparatus. Sheet Conveyance Path

Sheet conveyance paths provided in the printer 100 will be described. As illustrated in FIG. 1, the printer 100 includes the feeding path 307 and the duplex conveyance path 701.

The feeding path 307 is a sheet conveyance path (first conveyance path) in which the sheet S is fed from the cassette 20 toward the transfer portion 406. More specifically, the feeding path 307 in the present embodiment is a sheet conveyance path from a nip portion between the conveyance roller 301 and the separation roller 302 to the transfer portion. In the present embodiment, the sheet S that passes through the feeding path 307 reaches the transfer portion via the nip portion between the conveyance roller 301 and the separation roller 302, the nip portion of the intermediate roller pair 303, and the nip portion of the registration roller pair 304. In the present embodiment, the conveyance roller 301, the separation roller 302, the intermediate roller pair 303, and the registration roller pair 304 are disposed in the feeding path 307. The conveyance direction of the sheet S (movement direction of the sheet S) conveyed in the feeding path 307 toward the transfer portion 406 may be also referred to as a first conveyance direction Cv1.

In addition, a guide member that guides the sheet S is disposed in the feeding path 307. Pre-transfer guides (311, 312) that guide the sheet S at positions downstream of the registration roller pair 304 in the first conveyance direction Cv1 are provided in the feeding path 307 of the present embodiment. A first pre-transfer guide 311 is provided to oppose a first surface of the sheet S, and a second pre-transfer guide 312 is provided to oppose a second surface of the sheet S. The first surface mentioned herein is a surface (printing surface) of the sheet S that opposes the photosensitive drum 401 when the sheet S reaches the transfer portion 406 via the feeding path 307, and the second surface is a surface on the back side of the first surface.

Part of the conveyance space for the sheet S in the feeding path 307 is formed between the first pre-transfer guide 311 and the second pre-transfer guide 312 opposing each other. In addition, the first pre-transfer guide 311 and the second pre-transfer guide 312 are attached to the apparatus body 100A.

In addition, a first conveyance sensor 308 serving as a detection portion (first detection portion) that detects the position of the sheet S is disposed in the feeding path 307. The first conveyance sensor 308 is configured to output a signal corresponding to whether or not the sheet S is present at a predetermined detection position in the feeding path 307. The first conveyance sensor 308 includes, for example, a flag member configured to protrude in the feeding path 307 and swing by being pressed by the sheet S, and an optical sensor capable of detecting the swing of the flag member. The position where the leading end of the sheet S in the first conveyance direction Cv1 is detected by the first conveyance sensor 308 can be referred to as a first detection position. The first conveyance sensor 308 is provided such that the length of the movement path of the sheet S from the registration roller pair 304 to the first detection position is smaller than the length of the movement path of the sheet S from the first detection position to the transfer portion 406.

To be noted, the feeding path 307 and the sheet conveyance path from the transfer portion 406 to the discharge reverse portion 60 can be also collectively referred to as a main conveyance path (image forming path) of the printer 100. In other words, the printer 100 includes a main conveyance path and the duplex conveyance path 701, conveys the sheet S through the main conveyance path in the case of simplex printing, and conveys the sheet S through the main conveyance path and the duplex conveyance path 701 in the case of duplex printing.

The sheet S reversed by the discharge reverse roller pair 600 (reverse conveyance member) is conveyed toward the transfer portion 406 again through the duplex conveyance path 701. That is, the duplex conveyance path 701 is a sheet conveyance path (second sheet conveyance path) through which the sheet S reversed by the discharge reverse roller pair 600 (reverse conveyance member) is conveyed toward the transfer portion 406 again. More specifically, the duplex conveyance path 701 of the present embodiment is a sheet conveyance path from the nip portion of the discharge reverse roller pair 600 to a merging portion 705 where the duplex conveyance path 701 merges with the feeding path 307. In the present embodiment, the sheet S conveyed in the duplex conveyance path 701 reaches the merging portion 705 through the nip portion of the duplex conveyance roller pair 702. The conveyance direction of the sheet S (movement direction of the sheet S) conveyed in the duplex conveyance path 701 toward the transfer portion 406 may be also referred to as a second conveyance direction Cv2.

As illustrated in FIG. 1, in the first conveyance direction Cv1, the merging portion 705 is positioned downstream of the registration roller pair 304, which is the most downstream conveyance roller pair in the first conveyance direction Cv1 among the one or more first conveyance roller pairs disposed in the feeding path 307. In addition, in the second conveyance direction Cv2, the merging portion 705 is positioned downstream of the duplex conveyance roller pair 702, which is the most downstream conveyance roller pair in the second conveyance direction Cv2 among the one or more second conveyance roller pairs disposed in the duplex conveyance path 701. In addition, the first detection position is positioned upstream of the merging portion 705 in the first conveyance direction Cv1.

As illustrated in FIG. 1, the transfer portion 406 can be also referred to as a nip portion where the sheet S having passed through the merging portion 705 is nipped first. In other words, in the case where the sheet S is conveyed from the registration roller pair 304 to the transfer portion 406, the registration roller pair 304 is a roller pair disposed at a position closest to the transfer portion 406. Further, the merging portion 705 is closer to the transfer portion 406 than the registration roller pair 304. In the present embodiment, the sheet conveyance path from the registration roller pair 304 to the merging portion 705 is longer than the sheet conveyance path from the merging portion 705 to the transfer portion 406. In addition, in the case where the sheet S is conveyed from the duplex conveyance roller pair 702 to the transfer portion 406, the duplex conveyance roller pair 702 is a roller pair that is disposed at the position closest to the transfer portion 406. Further, the merging portion 705 is closer to the transfer portion 406 than the duplex conveyance roller pair 702. In the present embodiment, the sheet conveyance path from the duplex conveyance roller pair 702 to the merging portion 705 is longer than the sheet conveyance path from the merging portion 705 to the transfer portion 406.

In addition, a guide member that guides the sheet S is disposed in the duplex conveyance path 701. Turn guides (703, 706) that guide the sheet S at positions downstream of the duplex conveyance roller pairs 702 in the sheet conveyance direction in the duplex conveyance path 701 are disposed in the duplex conveyance path 701. An outer turn guide 703 and an inner turn guide 706 oppose each other, and are disposed such that the outer turn guide 703 opposes one surface of the sheet S and the inner turn guide 706 opposes the other surface of the sheet S. The one surface mentioned herein is a surface (printing surface) of the sheet S that opposes the photosensitive drum 401 when the sheet S reaches the transfer portion 406 through the duplex conveyance path 701, and the other surface is a surface on the back side of the printing surface. That is, the surface of the sheet S that opposes the outer turn guide 703 is a surface on the back side of the printing surface in the case of simplex printing.

Part of the conveyance space for the sheet S in the duplex conveyance path 701 is formed between the outer turn guide 703 and the inner turn guide 706 opposing each other. In addition, the outer turn guide 703 and the inner turn guide 706 are attached to the apparatus body 100A.

As illustrated in FIGS. 1 and 2, the duplex conveyance path 701 merges with the feeding path 307 at the merging portion 705 upstream of the transfer portion 406 in the first conveyance direction Cv1. FIG. 2 is an enlarged view of part of FIG. 1.

In the present embodiment, the merging portion 705 is an opening portion of the duplex conveyance path 701. The conveyance space of the duplex conveyance path 701 is configured to communicate with the conveyance space of the feeding path 307 at the merging portion 705. The merging portion 705 in the present embodiment is an opening portion defined by a downstream end 703a of the outer turn guide 703 in the second conveyance direction Cv2 and the inner turn guide 706. In the present embodiment, the merging portion 705 is defined by the downstream end 703a and a downstream end 706a of the inner turn guide 706 in the second conveyance direction Cv2.

As illustrated in FIGS. 1 and 2, the transfer roller 405 is disposed between the photosensitive drum 401 and the duplex conveyance path 701 in a direction orthogonal to the rotation axis of the photosensitive drum 401. In other words, part of the duplex conveyance path 701 is disposed on the opposite side to the photosensitive drum 401 with respect to the transfer roller 405 in a direction orthogonal to the rotation axis of the photosensitive drum 401.

As illustrated in FIGS. 1 and 2, the merging portion 705 is disposed on the same side as the transfer roller 405 with respect to the conveyance path for the sheet S in the feeding path 307. In other words, in the case where the side on which the photosensitive drum 401 is disposed is a first side and the side on which the transfer roller 405 is disposed is a second side in the feeding path 307 (first conveyance path), the merging portion 705 (opening portion) is disposed on the second side.

To be noted, the downstream end 703a of the outer turn guide 703 in the present embodiment is connected to a downstream end of the second pre-transfer guide 312 in the first conveyance direction Cv1. The merging portion 705 can be also referred to as a boundary between the duplex conveyance path 701 and the feeding path 307. The movement path of the sheet S conveyed in the duplex conveyance path 701 does not overlap with the movement path of the sheet S in the feeding path 307 (movement path in the case of simplex printing) before reaching the merging portion 705, and overlaps with the movement path of the sheet S in the feeding path 307 after reaching the merging portion 705. That is, the position where the leading end of the sheet S conveyed in the duplex conveyance path 701 reaches the merging portion 705 can be referred to as a position where the leading end of the sheet S conveyed in the duplex conveyance path 701 reaches the movement path of the sheet S in the case of simplex printing. After reaching the merging portion 705, the movement path of the sheet S intersects or matches with the movement path in the case of simplex printing.

The downstream end 703a of the outer turn guide 703 is positioned upstream of the downstream end 706a of the inner turn guide 706 in the conveyance direction (first conveyance direction Cv1) of the sheet S in the feeding path 307. In other words, the downstream end 703a of the outer turn guide 703 serving as an example of a guide member in the second conveyance direction Cv2 forms the upstream edge of the merging portion 705. That is, the downstream end 703a forms the upstream side, in the first conveyance direction Cv1, of the opening edge of the merging portion 705 (opening portion) where the conveyance space of the duplex conveyance path 701 (second conveyance path) communicates with the conveyance space of the feeding path 307 (first conveyance path).

Incidentally, the duplex conveyance path 701 (second conveyance path) includes a curved portion 707 (U-turn path, turn-around portion) where sheet S turns around toward the merging portion 705. The movement direction of the sheet S in the transfer portion 406 will be referred to as a first movement direction V1. The curved portion 707 (part of the duplex conveyance path 701/second conveyance path) is curved such that the sheet S conveyed in a direction opposite to the first movement direction V1 is guided in a direction following the first movement direction V1. In other words, guiding the sheet S in a direction following the first movement direction V1 indicates that the vector of the movement direction of the sheet S passing through the merging portion 705 serving as an exit of the duplex conveyance path 701 includes a component in the first movement direction V1. That is, regarding the sheet S having entered the feeding path 307 through the merging portion 705 from the duplex conveyance path 701, the trailing end of the sheet S in the second conveyance direction Cv2 passes through the transfer portion 406 after the leading end of the sheet S in the second conveyance direction Cv2 passes through the transfer portion 406.

More specifically, in the present embodiment, the movement direction of the sheet S in the transfer portion 406 as viewed in the X-axis direction is a direction toward one side (+Y side) in the horizontal direction. In contrast, in the duplex conveyance path 701, the sheet S is conveyed toward the other side (-Y side) in the horizontal direction through a space under the transfer portion 406. The curved portion 707 of the duplex conveyance path 701 is curved such that the sheet S conveyed toward the other side (-Y side) in the horizontal direction is turned around toward the one side (+Y side) in the horizontal direction as the sheet S moves upward. In other words, the curved portion 707 is formed in an approximate U shape opening toward the downstream side (+Y side) in the movement direction of the sheet S in the transfer portion 406.

The outer turn guide 703 forms at least part of the curved portion 707, and is disposed so as to guide the outer side of the sheet S curved in the curved portion 707.

### Image Forming Operation

Next, the image forming operation of the printer 100 in the present embodiment will be described. The image forming operation is a series of operation to form images on sheets S while conveying the sheets S one by one. In addition, the printer 100 is capable of executing the image forming operation in at least two modes including simplex printing to form an image on one surface of the sheet S and duplex printing to form an image on each surface of the sheet S.

The controller 100B of the printer 100 starts execution of the image forming operation when image information and an image forming command is transmitted to the printer 100 from an external apparatus such as a computer connected to the printer 100. When the image forming operation is started, the sheet S stacked in the cassette 20 is fed toward the conveyance roller 301 and the separation roller 302 by the pickup roller 300. The conveyance roller 301 and the separation roller 302 convey the sheet S further while performing separation of the sheet S. Specifically, in the case where a plurality of sheets S are fed out simultaneously, the separation roller 302 applies a frictional force to the sheet S in a separation nip between the conveyance roller 301 and the separation roller 302, and thus interrupts passage of sheets S other than the uppermost sheet S in contact with the conveyance roller 301. The sheet S having passed through the separation nip is conveyed to the registration roller pair 304 through the intermediate roller pair 303, and is further conveyed to the transfer portion 406 by the registration roller pair 304. In the present embodiment, the photosensitive drum 401 is rotated in accordance with the start of the image forming operation, but may be rotated in the case where arrival of the leading end of the sheet S in the first conveyance direction Cv1 at the first detection position is detected by the first conveyance sensor 308.

The controller 100B starts electrostatic image forming operation serving as a predetermined operation on the basis of detection of arrival of the leading end of the sheet S in the first conveyance direction Cv1 at the first detection position by the first conveyance sensor 308. That is, a signal output from the first conveyance sensor 308 changes in response to the arrival of the leading end of the sheet S in the first conveyance direction Cv1 at the first detection position. The controller 100B starts the electrostatic image forming operation on the basis of the change in the signal. The detection of the leading end of the sheet S in the first conveyance direction Cv1 by the first conveyance sensor 308 will be referred to as first leading end detection.

Here, “the electrostatic image forming operation is started on the basis of the first leading end detection” can be also referred to as “the electrostatic image forming operation is started in conjunction with the first leading end detection”. That is, it suffices as long as the timing of the first leading end detection is related to the timing at which the electrostatic image forming operation is started.

The electrostatic image forming operation includes at least an exposing process of the photosensitive drum 401 by the laser scanner 404. The exposing process refers to an operation in which the laser scanner 404 irradiates the photosensitive drum 401 with light and form a latent image on the photosensitive drum 401 for forming a toner image to be transferred onto the sheet S. In the present embodiment, the electrostatic image forming operation includes a charging process of the photosensitive drum 401 by the charging roller 402. The charging process refers to an operation in which a charging bias is applied to the charging roller 402 and thus the outer peripheral surface 401s of the photosensitive drum 401 that is rotating is charged. The charging process is performed before the exposing process. To be noted, the charging process may be started before the first leading end detection. That is, a configuration in which the electrostatic image forming operation includes only the exposing process may be employed. That is, the exposing process may be started on the basis of the first leading end detection. In contrast, the charging process may be started in conjunction with the first leading end detection, and the exposing process may be started on the basis of the start of the charging process.

In other words, it can be said that the exposing process is started in conjunction with the first leading end detection. That is, it suffices as long as the timing of the first leading end detection is related to the timing when the exposing process is started.

The start of the electrostatic image forming operation based on the first leading end detection will be described in further detail. The controller 100B transmits an image formation start signal on the basis of a signal output from the first conveyance sensor 308 (first detection portion). More specifically, the controller 100B transmits an image formation start signal on the basis of a situation in which a signal indicating that the sheet S has arrived at a predetermined position (first detection position) is output from the first conveyance sensor 308. The electrostatic image forming operation is performed on the basis of the image formation start signal. The electrostatic image formed by the static image forming operation is developed by the developing roller 403. This will be referred to as a developing process. The output of the image formation start signal is the same as the start of the electrostatic image forming operation.

The first conveyance sensor 308 is provided such that the conveyance distance of the sheet S from the detection position of the first conveyance sensor 308 to the transfer portion 406 is longer than a peripheral surface movement distance D2 (described later) of the photosensitive drum 401 from the charging portion 407 to the transfer portion 406. Therefore, the controller 100B can determine the timing of the image formation start signal on the basis of the change in the detection signal of the first conveyance sensor 308 occurring when the leading end of the sheet S passes the detection position. To be noted, the conveyance distance of the sheet S from the first detection position to the transfer portion 406 can be also referred to as the length of the movement path of the sheet S from the first detection position to the transfer portion 406.

The controller 100B can determine the timing of the image formation start signal such that the charged portion (portion charged at the charging portion 407) of the outer peripheral surface 401s of the photosensitive drum 401 reaches the transfer portion 406 at the same time as, for example, the arrival of the leading end of the sheet at the transfer portion 406. In addition, the controller 100B can determine the timing of the image formation start signal such that the leading end of the toner image formed on the photosensitive drum 401 reaches the transfer portion 406 at the same time as, for example, the arrival of the leading end of the sheet at the transfer portion 406. To be noted, the conveyance speed (peripheral speed of the registration roller pair 304) at which the registration roller pair 304 feeds the sheet S into the transfer portion 406 may be equal to the peripheral speed of the photosensitive drum 401 during image formation.

The developing roller 403 supplies toner to the photosensitive drum 401 on which an electrostatic latent image has been formed by exposure, and thus develops the electrostatic latent image into a toner image. The developed toner image is conveyed to the transfer portion 406 by the rotation of the photosensitive drum 401. Then, as a result of application of a transfer voltage to the transfer roller 405 from an unillustrated power source, the toner image is transferred from the photosensitive drum 401 to the sheet S when the sheet S passes through the transfer portion 406.

The sheet S onto which a toner image has been transferred is conveyed to the fixing unit 50. The fixing unit 50 fixes the toner image to the sheet S by heating and pressurizing the toner image on the sheet S while conveying the sheet S by the fixing roller 501 and the pressurizing roller 502.

In the case of simplex printing, the sheet S having passed through the fixing unit 50 is discharged onto the discharge tray 603 by the discharge reverse roller pair 600. In the case of duplex printing, the sheet S having passed through the fixing unit 50 is reversed by the discharge reverse roller pair 600, and conveyed to the duplex conveyance portion 70. Specifically, the discharge reverse roller pair 600 conveys the sheet S in a first direction toward the outside of the apparatus body 100A, and starts rotating in a reverse direction before the trailing end of the sheet S in the first direction passes through the nip portion of the discharge reverse roller pair 600. Then, the discharge reverse roller pair 600 conveys the sheet S in a second direction opposite to the first direction toward the duplex conveyance path 701

The sheet S conveyed to the duplex conveyance path 701 is further conveyed by the duplex conveyance roller pair 702, and is conveyed toward the merging portion 705 while being curved by the outer turn guide 703 at the curved portion 707. Then, the leading end of the sheet S passes through the merging portion 705, and reaches the transfer portion 406. At this time, a surface (second surface) of the sheet S on the opposite side to the surface (first surface) of the sheet S opposing the photosensitive drum 401 when the sheet S passes through the transfer portion 406 for the first time after being fed from the cassette 20 opposes the photosensitive drum 401. Then, the sheet S onto a second surface of which a toner image has been transferred is subjected to a toner image fixing process in the fixing unit 50, and then discharged onto the discharge tray 603 by the discharge reverse roller pair 600.

Positional Relationship between Merging Portion and Charging Portion

Here, the positional relationship between the charging portion 407 where the photosensitive drum 401 is charged by the charging roller 402 and the merging portion 705 where the duplex conveyance path 701 merges with the feeding path 307 will be described. The description below is based on the positional relationship as viewed in the direction of the rotation axis of the photosensitive drum 401 (X-axis direction) as illustrated in FIG. 2.

As illustrated in FIG. 2, as viewed in the direction of the rotation axis of the photosensitive drum 401 (X-axis direction), the minimum distance (straight-line distance) from the downstream end 703a of the outer turn guide 703 to the transfer portion 406 will be denoted by D1. Regarding the measurement of the distance D1, the position of the transfer portion 406 is the position of a crossing point between a virtual straight line z1 passing through the rotation axis 401A of the photosensitive drum 401 and a rotation axis 405A of the transfer roller 405 and the outer peripheral surface 401s of the photosensitive drum 401 that overlaps with the transfer portion 406. To be noted, as illustrated in FIG. 1, the duplex conveyance path 701 overlaps with the virtual straight line z1, and the transfer roller 405 is positioned between the photosensitive drum 401 and the duplex conveyance path 701 in the direction of the virtual straight line z1. Further, in the direction of the virtual straight line z1, the rotation axis 405A of the transfer roller 405 is positioned between the rotation axis 401A of the photosensitive drum 401 and the duplex conveyance path 701.

In addition, the peripheral surface movement distance of the photosensitive drum 401 from the charging portion 407 to the transfer portion 406 will be denoted by D2. More specifically, the peripheral surface movement distance D2 is the distance from the charging portion 407 to the transfer portion 406 measured along the outer peripheral surface 401s of the photosensitive drum 401 in the rotation direction R1 of the photosensitive drum 401 in image formation. The peripheral surface movement distance D2 can be also referred to as a distance by which an arbitrary point on the outer peripheral surface 401s of the photosensitive drum 401 rotating in the rotation direction R1 moves until reaching the transfer portion 406 for the first time after passing the charging portion 407.

The printer 100 of the present embodiment is configured such that the distance D1 from the downstream end 703a of the outer turn guide 703 to the transfer portion 406 is smaller than the peripheral surface movement distance D2 of the photosensitive drum 401 from the charging portion 407 to the transfer portion 406 (D1 < D2).

In other words, the merging portion 705 between the duplex conveyance path 701 and the feeding path 307 in the present embodiment is provided at a position close to the transfer portion 406 such that D1 < D2 is satisfied.

Here, a configuration in which the distance D1 from the downstream end 703a of the outer turn guide 703 to the transfer portion 406 is larger than the peripheral surface movement distance D2 of the photosensitive drum 401 (D1 > D2) is assumed as a comparative example. In the case of this comparative example, the conveyance distance of the sheet S from the discharge reverse roller pair 600 to the transfer portion 406 via the merging portion 705 is long. That is, the required time for the sheet S reversed by the discharge reverse roller pair 600 to be conveyed to the transfer portion 406 again is long, and thus the productivity of the duplex printing is likely to deteriorate.

In addition, according to the present embodiment, since the merging portion 705 is provided at a position close to the transfer portion 406 such that D1 < D2 is satisfied, the required time for the sheet S reversed by the discharge reverse roller pair 600 to be conveyed to the transfer portion 406 again can be shortened. As a result, the productivity of the duplex printing can be improved.

As described above, according to the present embodiment, an image forming apparatus capable of shortening the sheet conveyance path in the case of forming an image on each surface of the sheet can be provided.

In addition, in the comparative example described above, the duplex conveyance path 701 from the discharge reverse roller pair 600 to the merging portion 705 is longer than in the present embodiment. As the duplex conveyance path 701 is longer, the conveyance guide forming the duplex conveyance path 701 is larger, and the number of conveyance roller pairs disposed in the duplex conveyance path 701 needs to be increased, and therefore the size of the apparatus and the cost is increased. In contrast, according to the present embodiment, since the merging portion 705 is provided at a position close to the transfer portion 406, the duplex conveyance path 701 can be shortened, the size of the conveyance guide forming the duplex conveyance path 701 can be reduced, and the number of conveyance roller pairs disposed in the duplex conveyance path 701 can be reduced. As a result of this, the size and cost of the apparatus can be reduced.

In addition, according to the present embodiment, since the merging portion 705 is provided at a position close to the transfer portion 406, an additional conveyance roller pair does not need to be provided between the transfer portion 406 and the duplex conveyance roller pair 702 that is the most downstream conveyance roller pair in the duplex conveyance path 701. That is, since the sheet S can be conveyed from the duplex conveyance path 701 to the transfer portion 406 without providing an additional conveyance roller pair, it is advantageous for miniaturization of the printer 100. The conveyance roller pairs disposed in the duplex conveyance path 701 may be disposed such that the sheet S of the smallest size among sizes of the sheet S for which duplex printing in the printer 100 is allowed is always nipped in the nip of one or more conveyance roller pairs.

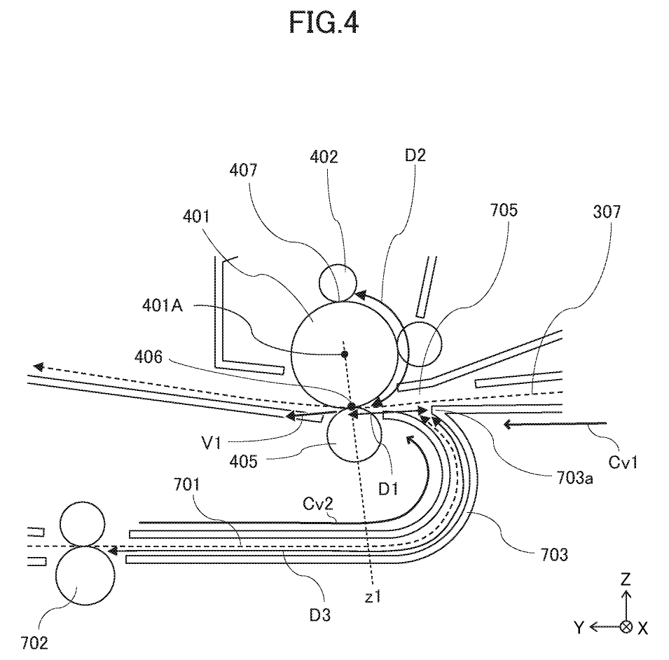

Particularly, according to the present embodiment, since the merging portion 705 is provided at a position close to the transfer portion 406 such that D1 < D2 is satisfied, the layout flexibility of the duplex conveyance roller pair 702 that is the most downstream conveyance roller pair in the duplex conveyance path 701 is improved. Specifically, as viewed in the direction of the rotation axis of the photosensitive drum 401 (FIG. 4), the duplex conveyance roller pair 702 positioned most downstream may be disposed in a region downstream of the virtual straight line z1 described above in the first movement direction V1. The virtual straight line z1 can be referred to as a straight line that interconnects the photosensitive drum 401 and the transfer roller 405, passes through the rotation axis of the photosensitive drum 401, and is orthogonal to the movement direction (first movement direction V1) of the sheet S in the transfer portion 406. In addition, as viewed in the direction of the rotation axis of the photosensitive drum 401, the duplex conveyance roller pair 702 positioned most downstream may be disposed in a region upstream of the virtual straight line z1 in the second conveyance direction Cv2.

In the case where the merging portion 705 is at a position away from the transfer portion 406, the duplex conveyance roller pair 702 positioned most downstream needs to be disposed at a position close to the merging portion 705 to allow the duplex conveyance roller pair 702 positioned most downstream to stably convey sheets S of various sizes to the transfer portion 406. That is, the duplex conveyance roller pair 702 positioned most downstream is disposed in a region upstream of the virtual straight line z1 in the first movement direction V1. In contrast, in the present embodiment, the merging portion 705 is provided at a position close to the transfer portion 406. Therefore, also in the case where the duplex conveyance roller pair 702 positioned most downstream is disposed in a region downstream of the virtual straight line z1 in the first movement direction V1, the duplex conveyance roller pair 702 positioned most downstream can stably convey the sheet S to the transfer portion 406. In addition, since the duplex conveyance roller pair 702 positioned most downstream can be disposed at a position downstream of the virtual straight line z1 in the first movement direction V1, the number of conveyance roller pairs disposed in the duplex conveyance path 701 can be reduced in some cases.

### First Modification Example

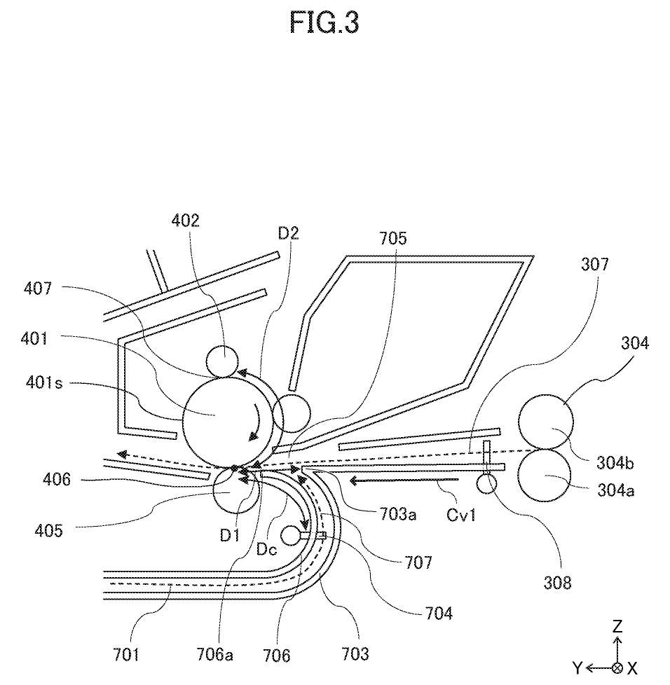

A configuration of a modification example (first modification example) of the first embodiment will be described with reference to FIG. 3. FIG. 3 is an enlarged view of part of a cross-section of the printer 100 according to the first modification example, and is a diagram corresponding to FIG. 2 of the first embodiment. In the description below, it is assumed that elements denoted by the same reference signs as in the first embodiment basically have the same configurations and functions as those described in the first embodiment unless described otherwise, and part different from the first embodiment will be mainly described.

In the first modification example, a second conveyance sensor 704 serving as a detection portion (second detection portion) that detects the position of the sheet S is disposed in the duplex conveyance path 701. The second conveyance sensor 704 of the present modification example is disposed in the curved portion 707 of the duplex conveyance path 701. The position where the leading end of the sheet S in the second conveyance direction Cv2 is detected by the second conveyance sensor 704 can be referred to as a second detection position. The length of the movement path of the sheet S from the second detection position to the transfer portion 406 is smaller than the length of the movement path of the sheet S from the first detection position to the transfer portion 406. In addition, the second detection position is positioned upstream of the merging portion 705 in the second conveyance direction Cv2.

The second conveyance sensor 704 is configured to output a signal corresponding to whether or not the sheet S is present at a predetermined detection position in the duplex conveyance path 701. The second conveyance sensor 704 includes, for example, a flag member configured to protrude in the duplex conveyance path 701 and swing by being pressed by the sheet S, and an optical sensor capable of detecting the swing of the flag member. The controller 100B starts electrostatic image forming operation serving as a predetermined operation on the basis of detection of arrival of the leading end of the sheet S in the second conveyance direction Cv2 at the second detection position by the second conveyance sensor 704. The detection of the leading end of the sheet S in the second conveyance direction Cv2 by the second conveyance sensor 704 will be referred to as second leading end detection. The start of the electrostatic image forming operation based on the second leading end detection is substantially the same as the start of the electrostatic image forming operation based on the first leading end detection, and therefore detailed description thereof will be omitted. To be noted, the interval between the timing of the first leading end detection and the timing of the electrostatic image forming operation may be different from the interval between the timing of the second leading end detection and the timing of the electrostatic image forming operation.

The second conveyance sensor 704 is provided such that a conveyance distance Dc of the sheet S from the detection position of the second conveyance sensor 704 (second detection position) to the transfer portion 406 is longer than the peripheral surface movement distance D2 of the photosensitive drum 401 from the charging portion 407 to the transfer portion 406 (D2 < Dc). Therefore, the controller 100B can determine the timing of the image formation start signal for forming an image on the second surface of the sheet S on the basis of the change in the detection signal of the second conveyance sensor 704 occurring when the leading end of the sheet S passes the detection position. To be noted, the conveyance distance Dc of the sheet S from the second detection position to the transfer portion 406 can be also referred to as the length of the movement path of the sheet S from the second detection position to the transfer portion 406.

The controller 100B can determine the timing of the image formation start signal such that the charged portion (portion charged at the charging portion 407) of the outer peripheral surface 401s of the photosensitive drum 401 reaches the transfer portion 406 at the same time as, for example, the arrival of the leading end of the sheet S at the transfer portion 406. In addition, the controller 100B can determine the timing of the image formation start signal such that the leading end of the toner image formed on the photosensitive drum 401 reaches the transfer portion 406 at the same time as, for example, the arrival of the leading end of the sheet conveyed from the duplex conveyance path 701 at the transfer portion 406.

That is, in the case of forming an image on each of the first surface and the second surface of the sheet S, after the sheet S on the first surface of which an image has been formed is reversed by the discharge reverse roller pair 600 (reverse conveyance member), the controller 100B causes the laser scanner 404 (exposing unit) to start the exposing process on the basis of a signal from the second conveyance sensor 704 (second detection portion). Particularly, the controller 100B starts the exposing process on the basis of detection of the leading end of the sheet in the second conveyance direction Cv2 based on the signal from the second conveyance sensor 704 (second detection portion).

Also in the first modification example, since the distance D1 from the downstream end 703a of the outer turn guide 703 to the transfer portion 406 is smaller than the peripheral surface movement distance D2 of the photosensitive drum 401 (D1 < D2), the length of the sheet conveyance path in the case of forming an image on each surface of the sheet can be reduced.

In addition, in the first modification example, the peripheral surface movement distance D2 of the photosensitive drum 401 is larger than the distance D1 from the downstream end 703a of the outer turn guide 703 to the transfer portion 406 and smaller than the conveyance distance Dc of the sheet S from the detection position of the second conveyance sensor 704 to the transfer portion 406. That is, there is a relationship of D1 < D2 < Dc. As a result of this, the controller 100B can start the exposure of the photosensitive drum 401 on the basis of the detection of the sheet leading end by the second conveyance sensor 704 while shortening the duplex conveyance path 701.

### Second Embodiment

Next, a second embodiment will be described with reference to FIG. 4. FIG. 4 is a section view for describing the configuration of the duplex conveyance portion 70 of the second embodiment. In the description below, it is assumed that elements denoted by the same reference signs as in the first embodiment basically have the same configurations and functions as those described in the first embodiment unless described otherwise, and part different from the first embodiment will be mainly described.

As illustrated in FIG. 4, the conveyance distance of the sheet S from the duplex conveyance roller pair 702 positioned most downstream in the duplex conveyance path 701 to the merging portion 705 will be denoted by D3. The conveyance distance D3 can be also referred to as the length of the movement path of the sheet S from the most downstream conveyance roller pair in the second conveyance direction Cv2 among the one or more conveyance roller pairs disposed in the duplex conveyance path 701 (second conveyance path) to the merging portion 705. In the present embodiment, the conveyance distance D3 is equal to or larger than at least a double of the distance D1.

In the present embodiment, a configuration in which the distance D1 from the downstream end 703a of the outer turn guide 703 to the transfer portion 406 is smaller than the conveyance distance D3 is employed (D1 < D3).

In other words, the merging portion 705 between the duplex conveyance path 701 to the feeding path 307 in the present embodiment is provided at a position close to the transfer portion 406 so as to satisfy the relationship of D1 < D3.

To be noted, a surface of the outer turn guide 703 opposing the duplex conveyance path 701 will be referred to as a guide surface. Depending on the thickness of the sheet S or the like, part of the guide surface can come into contact with the sheet S. However, it can be said that the length measured along the guide surface from the duplex conveyance roller pair 702 positioned most downstream to the downstream end 703a of the outer turn guide 703 is approximately the largest length of the movement path that the sheet S can take. In the present embodiment, the distance D1 from the downstream end 703a of the outer turn guide 703 to the transfer portion 406 is smaller than the length measured along the guide surface from the duplex conveyance roller pair 702 positioned most downstream to the downstream end 703a of the outer turn guide 703. Therefore, the distance measured from the duplex conveyance roller pair 702 to the merging portion 705 along the center line of the duplex conveyance path 701 is also larger than the distance D1. The center line of the duplex conveyance path 701 is a virtual line that is in an equal distance from the guide members (inner turn guide 706 and outer turn guide 703) opposing each other to define the conveyance space of the duplex conveyance path 701. Also in this case, the distance measured along the center line is at least a double or more of the distance D1.

According to the present embodiment, as compared with a configuration in which the merging portion 705 is provided at a position far from the transfer portion 406 such that the distance D1 is larger than the conveyance distance D3 (D1 > D3), the length of the sheet conveyance path in the case of forming an image on each surface of the sheet can be reduced. As a result of this, the productivity of duplex printing can be improved. In addition, since the duplex conveyance path 701 can be shortened, the sizes of the conveyance guides defining the duplex conveyance path 701 can be reduced, the number of the conveyance roller pairs disposed in the duplex conveyance path 701 can be reduced, and thus the size and cost of the apparatus can be reduced.

As described above, according to the present embodiment, an image forming apparatus capable of shortening the sheet conveyance path in the case of forming an image on each surface of the sheet can be provided.

In addition, according to the present embodiment, since the merging portion 705 is provided at a position close to the transfer portion 406 such that D1 < D3 is satisfied, the layout flexibility of the duplex conveyance roller pair 702 that is the most downstream conveyance roller pair in the duplex conveyance path 701 is improved. Specifically, as viewed in the direction of the rotation axis of the photosensitive drum 401 (FIG. 4), the duplex conveyance roller pair 702 positioned most downstream may be disposed in a region downstream of the virtual straight line z1 in the first movement direction V1. In addition, since the duplex conveyance roller pair 702 positioned most downstream can be disposed in a region downstream of the virtual straight line z1 in the first movement direction V1, the number of conveyance roller pairs disposed in the duplex conveyance path 701 can be reduced in some cases.

The configuration of the present embodiment may be combined with the configuration of the first embodiment. That is, the merging portion 705, the charging portion 407, the duplex conveyance roller pair 702 positioned most downstream, and the like may be disposed such that both D1 < D3 and D1 < D2 are satisfied in one printer 100.

### Second Modification Example

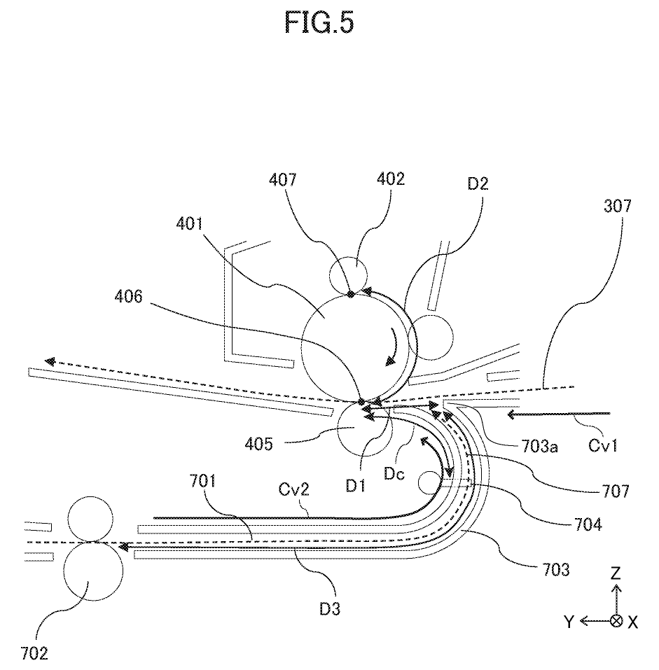

A configuration of a modification example (second modification example) of the second embodiment will be described with reference to FIG. 5. FIG. 5 is an enlarged view of part of a cross-section of the printer 100 according to the second modification example, and is a diagram corresponding to FIG. 4 of the second embodiment. In the description below, it is assumed that elements denoted by the same reference signs as in the second embodiment basically have the same configurations and functions as those described in the second embodiment unless described otherwise, and part different from the second embodiment will be mainly described.

In the second modification example, a second conveyance sensor 704 serving as a detection portion (second detection portion) that detects the position of the sheet S is disposed in the duplex conveyance path 701. The second conveyance sensor 704 of the present modification example is disposed in the curved portion 707 of the duplex conveyance path 701. The second conveyance sensor 704 includes, for example, the flag member and the optical sensor described in the first modification example.

The second conveyance sensor 704 is provided such that the conveyance distance Dc of the sheet S from the detection position of the second conveyance sensor 704 to the transfer portion 406 is longer than the peripheral surface movement distance D2 of the photosensitive drum 401 from the charging portion 407 to the transfer portion 406 (D2 < Dc). Therefore, the controller 100B can determine the timing of the image formation start signal for forming an image on the second surface of the sheet S on the basis of the change in the detection signal of the second conveyance sensor 704 occurring when the leading end of the sheet S passes the detection position. To be noted, the conveyance speed at which the duplex conveyance roller pair 702 feeds the sheet S into the transfer portion 406 (peripheral speed of duplex conveyance roller pair 702) may be equal to the peripheral speed of the photosensitive drum 401 in image formation.

Also in the second modification example, the distance D1 from the downstream end 703a of the outer turn guide 703 to the transfer portion 406 is smaller than the conveyance distance D3 from the duplex conveyance roller pair 702 to the merging portion 705 (D1 < D3). Therefore, the duplex conveyance path 701 can be shortened.

In addition, in the second modification example, the peripheral surface movement distance D2 of the photosensitive drum 401 is longer than the distance D1 from the downstream end 703a of the outer turn guide 703 to the transfer portion 406, and is shorter than the conveyance distance Dc of the sheet S from the detection position of the second conveyance sensor 704 to the transfer portion 406. That is, a relationship of D1 < D2 < Dc is satisfied. As a result of this, the controller 100B can start the exposure of the photosensitive drum 401 on the basis of the detection of the leading end of the sheet by the second conveyance sensor 704 while shortening the duplex conveyance path 701.

### Third Modification Example

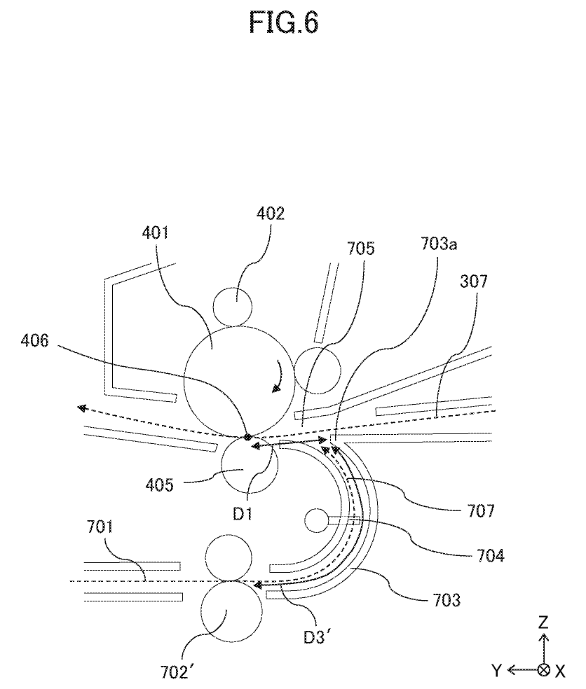

A configuration of another modification example (third modification example) of the second embodiment will be described with reference to FIG. 6. FIG. 6 is an enlarged view of part of a cross-section of the printer 100 according to the third modification example, and is a diagram corresponding to FIG. 4 of the second embodiment. In the description below, it is assumed that elements denoted by the same reference signs as in the second embodiment basically have the same configurations and functions as those described in the second embodiment unless described otherwise, and part different from the second embodiment will be mainly described.

As illustrated in FIG. 6, a duplex conveyance roller pair 702’ of the present embodiment is disposed at a position downstream of the duplex conveyance roller pair 702 of the first and second embodiments in the second conveyance direction Cv2. The duplex conveyance roller pair 702’ may be disposed in the curved portion 707 of the duplex conveyance path 701.

Also in the present modification example, a configuration in which the distance D1 from the downstream end 703a of the outer turn guide 703 to the transfer portion 406 is smaller than a conveyance distance D3’ from the duplex conveyance roller pair 702 to the merging portion 705 is employed (D1 < D3’). In other words, the merging portion 705 between the duplex conveyance path 701 to the feeding path 307 in the present embodiment is provided at a position close to the transfer portion 406 so as to satisfy the relationship of D1 < D3’.

Therefore, an image forming apparatus capable of shortening the sheet conveyance path in the case of forming an image on each surface of the sheet can be provided.

In addition, in the present embodiment, the conveyance distance of the sheet S from the duplex conveyance roller pair 702’ to the transfer portion 406 (sum of D1 and D3’) is shorter than the conveyance distance of the sheet S from the duplex conveyance roller pair 702 to the transfer portion 406 in the first and second embodiments (sum of D1 and D3). For example, in the case of conveying a sheet S having high stiffness such as a cardboard, the frictional drag that the sheet S receives from the outer turn guide 703 and the inner turn guide 706 in the curved portion 707 is large. According to the present embodiment, since the conveyance distance of the sheet S from the duplex conveyance roller pair 702’ to the transfer portion 406 is short, the sheet S is likely to be stably conveyed to the transfer portion 406 by the duplex conveyance roller pair 702’ even in the case of conveying a cardboard or the like.

### Other Embodiments

In the embodiments described above, a configuration in which after the sheet S is fed toward one side (-Y side) in the horizontal direction from the cassette 20, a toner image is transferred onto the sheet S conveyed toward the other side (+Y side) in the horizontal direction at a position above the cassette 20 has been described as an example. In addition, in the embodiments described above, a configuration in which the sheet S is discharged to the outside of the apparatus body 100A toward one side (-Y side) in the horizontal direction at a position above the image forming portion 40 has been described as an example. That is, in the embodiments described above, an image forming apparatus having a so-called S-path layout (horizontal path layout) in which the sheet conveyance path in the image forming apparatus is formed in an S shape has been described as an example.

The technique of the present disclosure is not limited to this, and may be applied to an image forming apparatus of a so-called C-path layout (vertical path layout) in which the sheet conveyance path in the image forming apparatus is formed in a C shape. The C-path layout is a configuration in which after a sheet is fed from the cassette 20 toward one side in the horizontal direction, a toner image is transferred onto the sheet conveyed upward, and the sheet is discharged to the outside of the apparatus body 100A toward the other side in the horizontal direction at a position above the image forming portion 40.

In the case of the C-path layout, the feeding path 307 is formed to extend upward on one end side (right end side in FIG. 1) of the apparatus body 100A in the horizontal direction. In addition, in the case of the C-path layout, the duplex conveyance path 701 is formed to extend in an approximate up-down direction at a position further on one end side (right end side in FIG. 1) of the apparatus body 100A than the feeding path 307 and the transfer portion 406 in the horizontal direction. A curved portion curved in an approximate U shape such that the sheet S conveyed downward is turned around toward the merging portion between the duplex conveyance path 701 and the feeding path 307 is provided at a lower portion of the duplex conveyance path 701.

Also in the image forming apparatus of the C-path layout, a configuration described in the embodiments described above can be applied, and the duplex conveyance path 701 can merge with the feeding path 307 at a position close to the transfer portion 406. As a result of this, an image forming apparatus capable of shortening the sheet conveyance path in the case of forming an image on each surface of the sheet can be provided.

In an image forming apparatus capable of forming an image on each surface of the sheet, a path in which the sheet reversed after an image is formed on a first surface of the sheet is conveyed toward the image forming portion again to form an image on a second surface of the sheet may preferably be short.

According to the present disclosure, an image forming apparatus capable of shortening the sheet conveyance path in the case of forming an image on each surface of the sheet can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application Nos. 2025-014004, filed January 30, 2025, and 2025-189117, filed November 10, 2025, which are hereby incorporated by reference herein in their entirety.

What is claimed is:

1. An image forming apparatus comprising:
a photosensitive drum;
a charging member configured to charge an outer peripheral surface of the photosensitive drum at a charging portion;
a transfer member configured to transfer a toner image from the photosensitive drum onto a sheet at a transfer portion;
a stacking tray on which the sheet is stacked;
a first conveyance path through which the sheet is conveyed from the stacking tray to the transfer portion;
one or more first conveyance roller pairs disposed in the first conveyance path;
a reverse conveyance member configured to reverse the sheet having passed through the transfer portion;
a second conveyance path through which the sheet reversed by the reverse conveyance member is conveyed toward the transfer portion; and
one or more second conveyance roller pairs disposed in the second conveyance path,
wherein in a case where a conveyance direction of the sheet in the first conveyance path is a first conveyance direction and a conveyance direction of the sheet in the second conveyance path is a second conveyance direction, the second conveyance path merges with the first conveyance path at a position upstream of the transfer portion in the first conveyance direction,
the second conveyance path includes a guide member configured to guide the sheet,
a downstream end of the guide member in the second conveyance direction forms an upstream edge, in the first conveyance direction, of an opening portion that is a merging portion where a conveyance space of the second conveyance path communicates with a conveyance space of the first conveyance path, and
as viewed in a direction of a rotation axis of the photosensitive drum, a minimum distance from the downstream end of the guide member to the transfer portion is smaller than a distance from the charging portion to the transfer portion measured along the outer peripheral surface of the photosensitive drum in a rotation direction of the photosensitive drum during image formation.

2. The image forming apparatus according to claim 1,
wherein as viewed in the direction of the rotation axis of the photosensitive drum, the minimum distance from the downstream end of the guide member to the transfer portion is smaller than a length of a movement path from a most downstream conveyance roller pair in the second conveyance direction among the one or more second conveyance roller pairs to the merging portion.

3. The image forming apparatus according to claim 2,
wherein in a case where a movement direction of the sheet in the transfer portion is a first movement direction, the most downstream conveyance roller pair is disposed in a region downstream of a virtual straight line in the first movement direction, the virtual straight line passing through the rotation axis of the photosensitive drum and being orthogonal to the first movement direction.

4. The image forming apparatus according to claim 3,
wherein the second conveyance path includes a curved portion that is curved such that the sheet conveyed in a direction opposite to the first movement direction is guided in a direction following the first movement direction, and
the most downstream conveyance roller pair is disposed at a position upstream of the curved portion in the second conveyance direction.

5. The image forming apparatus according to claim 4,
wherein the guide member forms at least part of the curved portion and is configured to guide an outer side of the sheet curved in the curved portion.

6. The image forming apparatus according to claim 1, further comprising:
a first detection portion disposed in the first conveyance path and configured to detect the sheet;
an exposing unit configured to perform an exposing process to form a latent image on the outer peripheral surface of the photosensitive drum that has been charged by the charging member, by irradiating the outer peripheral surface with light; and
a controller configured to start a predetermined operation on a basis of detection of arrival of a leading end of the sheet in the first conveyance direction at a first detection position by the first detection portion,
wherein the predetermined operation includes the exposing process.

7. The image forming apparatus according to claim 6,
wherein the first detection position is positioned upstream of the merging portion in the first conveyance direction.

8. The image forming apparatus according to claim 6,
wherein a length of a movement path of the sheet from a most downstream conveyance roller pair in the first conveyance direction among the one or more first conveyance roller pairs to the first detection position is smaller than a length of a movement path of the sheet from the first detection position to the transfer portion.

9. The image forming apparatus according to claim 6, further comprising:
a second detection portion disposed in the second conveyance path and configured to detect the sheet,
wherein the controller is configured to start the predetermined operation on a basis of detection of arrival of a leading end of the sheet in the second conveyance direction at a second detection position by the second detection portion.

10. The image forming apparatus according to claim 9,
wherein in a case where a movement direction of the sheet in the transfer portion is a first movement direction, the second conveyance path includes a curved portion that is curved such that the sheet conveyed in a direction opposite to the first movement direction is guided in a direction following the first movement direction, and
the second detection position is in the curved portion.

11. The image forming apparatus according to claim 9,
wherein a length of a movement path of the sheet from the second detection position to the transfer portion is smaller than a length of a movement path of the sheet from the first detection position to the transfer portion.

12. The image forming apparatus according to claim 1,
wherein the merging portion is positioned downstream, in the first conveyance direction, of a conveyance roller pair that is positioned most downstream in the first conveyance direction among the one or more first conveyance roller pairs, and
the merging portion is positioned downstream, in the second conveyance direction, of a conveyance roller pair that is positioned most downstream in the second conveyance direction among the one or more second conveyance roller pairs.

13. An image forming apparatus comprising:
a photosensitive drum;
a charging member configured to charge an outer peripheral surface of the photosensitive drum at a charging portion;
a transfer member configured to transfer a toner image from the photosensitive drum onto a sheet at a transfer portion;
a stacking tray on which the sheet is stacked;
a first conveyance path through which the sheet is conveyed from the stacking tray to the transfer portion;
one or more first conveyance roller pairs disposed in the first conveyance path;
a reverse conveyance member configured to reverse the sheet having passed through the transfer portion;
a second conveyance path through which the sheet reversed by the reverse conveyance member is conveyed toward the transfer portion; and
one or more second conveyance roller pairs disposed in the second conveyance path,
wherein the transfer member is disposed between the photosensitive drum and the second conveyance path,
in a case where a conveyance direction of the sheet in the first conveyance path is a first conveyance direction and a conveyance direction of the sheet in the second conveyance path is a second conveyance direction, the second conveyance path merges with the first conveyance path at a position upstream of the transfer portion in the first conveyance direction,
the second conveyance path includes a guide member configured to guide the sheet,
a downstream end of the guide member in the second conveyance direction forms an upstream edge, in the first conveyance direction, of an opening portion that is a merging portion where a conveyance space of the second conveyance path communicates with a conveyance space of the first conveyance path, and
as viewed in a direction of a rotation axis of the photosensitive drum, a minimum distance from the downstream end of the guide member to the transfer portion is smaller than a length of a movement path of the sheet from a most downstream conveyance roller pair in the second conveyance direction among the one or more second conveyance roller pairs to the merging portion.

14. The image forming apparatus according to claim 13,
wherein in a case where a movement direction of the sheet in the transfer portion is a first movement direction, the most downstream conveyance roller pair is disposed in a region downstream of a virtual straight line in the first movement direction, the virtual straight line passing through the rotation axis of the photosensitive drum and being orthogonal to the first movement direction.

15. The image forming apparatus according to claim 14,
wherein the second conveyance path includes a curved portion that is curved such that the sheet conveyed in a direction opposite to the first movement direction is guided in a direction following the first movement direction, and
the most downstream conveyance roller pair is disposed at a position upstream of the curved portion in the second conveyance direction.

16. The image forming apparatus according to claim 15,
wherein the guide member forms at least part of the curved portion and is configured to guide an outer side of the sheet curved in the curved portion.

17. The image forming apparatus according to claim 13, further comprising:
a first detection portion disposed in the first conveyance path and configured to detect the sheet;
an exposing unit configured to perform an exposing process to form a latent image on the outer peripheral surface of the photosensitive drum that has been charged by the charging member, by irradiating the outer peripheral surface with light; and
a controller configured to start a predetermined operation on a basis of detection of arrival of a leading end of the sheet in the first conveyance direction at a first detection position by the first detection portion,
wherein the predetermined operation includes the exposing process.

18. The image forming apparatus according to claim 17,
wherein the first detection position is positioned upstream of the merging portion in the first conveyance direction.

19. The image forming apparatus according to claim 17,
wherein a length of a movement path of the sheet from a most downstream conveyance roller pair in the first conveyance direction among the one or more first conveyance roller pairs to the first detection position is smaller than a length of a movement path of the sheet from the first detection position to the transfer portion.

20. The image forming apparatus according to claim 17, further comprising:
a second detection portion disposed in the second conveyance path and configured to detect the sheet,
wherein the controller is configured to start the predetermined operation on a basis of detection of arrival of a leading end of the sheet in the second conveyance direction at a second detection position by the second detection portion.

21. The image forming apparatus according to claim 20,
wherein in a case where a movement direction of the sheet in the transfer portion is a first movement direction, the second conveyance path includes a curved portion that is curved such that the sheet conveyed in a direction opposite to the first movement direction is guided in a direction following the first movement direction, and
the second detection position is in the curved portion.

22. The image forming apparatus according to claim 20,
wherein a length of a movement path of the sheet from the second detection position to the transfer portion is smaller than a length of a movement path of the sheet from the first detection position to the transfer portion.

23. The image forming apparatus according to claim 13,
wherein the merging portion is positioned downstream, in the first conveyance direction, of a conveyance roller pair that is positioned most downstream in the first conveyance direction among the one or more first conveyance roller pairs, and
the merging portion is positioned downstream, in the second conveyance direction, of a conveyance roller pair that is positioned most downstream in the second conveyance direction among the one or more second conveyance roller pairs.
